(19) United States
(12) Patent Application Publication
(10) Pub. No.: US 2011/0072834 A1
(43) Pub. Date: Mar. 31, 2011

(54) COOLING STRUCTURE OF ELECTRONIC EQUIPMENT

(75) Inventors: Mitsuo Ishikura, Yokohama (JP); Shinya Hamagishi, Fujisawa (JP); Nobuhiro Tamayama, Yokohama (JP)

(73) Assignee: Hitachi, Ltd.

(21) Appl. No.: 12/841,471

(22) Filed: Jul. 22, 2010

(30) Foreign Application Priority Data
Sep. 30, 2009 (JP) 2009-227561

(51) Int. Cl. F25B 21/02; G05D 23/00

(52) U.S. Cl. 62/3.2; 165/287

(57) ABSTRACT

In an environment in which influence of heat energy from the outside is received, for example, when a large temperature difference occurs in an electronic equipment by external factors such as solar insolation or when a temperature difference occurs in the electronic equipment by heat of another device installed in the neighborhood, it is difficult to stabilize the temperature of the equipment within an allowable temperature range due to the influence of the external environment. An electronic equipment has a structure in which an electronic component contained in a housing is thermally connected to a housing inner wall through plural heat conduction members and a heat conduction control member, and the amount of heat transported from the electronic component to the housing inner wall is controlled by using the heat conduction control member. The amount of heat to be transported is decreased for a housing surface whose temperature rises by influence of the external environment, the amount of heat to be transported is increased for a housing surface which is not influenced by the external environment, and the temperature of the electronic component is stabilized within the allowable temperature range.

### CLAIM OF PRIORITY

The present application claims priority from Japanese patent application JP 2009-227561 filed on Sep. 30, 2009, the content of which is hereby incorporated by reference into this application.

### BACKGROUND OF THE INVENTION

1. Field of the Invention

The present invention relates to a cooling structure of an electronic equipment, and particularly to a cooling structure of an electronic equipment in which in the electronic equipment installed outdoors, when a temperature difference occurs in the electronic equipment due to external factors such as solar insolation or temperature difference in atmospheric temperature, or when a temperature difference occurs in the electronic equipment due to heat of another device installed in the neighborhood, the influence of the heat energy from the outside is reduced, and the temperature of the equipment is stabilized within an allowable temperature range.

2. Description of the Related Art

In recent years, with an improvement in function and an increase in density of an electronic equipment, management of heat generated from the equipment becomes a serious problem. Particularly, in a precision equipment, an allowable temperature range at the time of operation is often limited, and a requirement relating to the management of heat is a severe design condition.

When such an equipment is installed especially outdoors, since a temperature difference occurs between a portion which receives solar insolation and a portion which does not receive solar insolation, it is difficult to keep the temperature of the entire equipment within the allowable temperature range.

FIG. 2 is a conceptual view showing an electronic equipment installed outdoors. In this electronic equipment, a printed board 21 is contained in a housing 20. An electronic component 22 is mounted on the printed board 21, and in order to dissipate the heat of the electronic component 22, a housing inner wall and the electronic component 22 are thermally connected to each other. The phrase “thermally connected” means “thermally joined”, and for example, the heat generated from the electronic component 22 is connected using a heat sink or the like and is conducted to the housing outer wall. The generated heat is released from the housing outer wall to the atmosphere, and temperature rise in the housing is suppressed.

However, when the electronic equipment receives solar insolation, since the amount of insolation is about 1 KW/m² in summary, the temperature of the housing outer wall receiving the insolation can be 80° C. or higher. At this time, the temperature of the electronic component 22 becomes higher than the temperature of the housing inner wall by its own heat generation, and therefore, it is difficult to use the electronic equipment 22 under the use environment condition (temperature, humidity, etc.).

Thus, in the electronic equipment installed outdoors, there is a case where a light shielding plate for shielding solar insolation is attached. As shown in FIG. 3, a light shielding plate 24 is attached so as to a cover a portion receiving solar insolation. Thus, in order to install the light shielding plate 24, it is necessary to previously grasp the direction of solar insolation. When the direction of solar insolation can not be specified, the light shielding plate is generally attached to five surfaces except the equipment bottom surface. However, in this method, there is a problem that the electronic equipment becomes large.

As an example of a case where consideration is given to the reduction of the temperature rise caused by solar insolation and the miniaturization of an electronic equipment, there is a technique disclosed in JP-A-2001-57485 (patent document 1).

FIG. 4 is a structure conceptual view showing the electronic equipment disclosed in the above publication. In FIG. 4, the electronic equipment includes, in a metal closed housing 40, a printed board 41, an electronic component 42, directional heat conduction members 43, and a low heat resistance member 44. In this electronic equipment, in order to cool the electronic component 42, the electronic component 42 is connected to the closed housing 40 through the plural directional heat conduction members 43 and the low heat resistance member 44. By this, heat generated from the electronic component 42 is transported to the closed housing outer wall through the directional heat conduction members 43 and the low heat resistance member 44, and is released to the atmosphere. Incidentally, the directional heat conduction members 43 are disposed so as to conduct heat only in the direction from the electronic component 42 to the housing outside. Thus, when the electronic equipment receives solar insolation, heat of the housing outer wall surface whose temperature rises by receiving the insolation is not conducted to the electronic component 42 in the housing through the directional heat conduction members 43.

[Patent document 1] JP-A-2001-57485

### SUMMARY OF THE INVENTION

However, when it is considered to keep the temperature of the electronic equipment within an allowable temperature range, the technique disclosed in the publication has following problems.

In the technique disclosed in the publication, a heat pipe is used as the directional heat transmission member. When a temperature difference occurs between a heat absorption portion and a heat dissipation portion, the heat pipe immediately transports heat from the heat absorption side to the heat dissipation side. At this time, the operation temperature of the heat pipe is passively determined by the temperature of the heat absorption portion and the heat dissipation portion.

Thus, in the structure of the electronic equipment in which the heat absorption portion of the heat pipe is connected to the electronic component and the heat dissipation portion is connected to the housing inner wall, when the temperature of the housing inner wall (heat dissipation portion) is changed by solar insolation, the temperature of the electronic component (heat absorption portion) is also passively changed, and this can not be kept at a specified temperature.

Besides, since a metal pipe is used as the heat pipe, heat conduction efficiency as expected can not be obtained, heat energy from the external environment such as the solar insolation is transported into the equipment, and it is liable to be influenced by external environmental factors such as the solar insolation. In other words, in the electronic equipment structure, it can not be expected that the influence of the external environmental factors is greatly reduced.

The present invention is made in view of the above circumstances, and in an environment in which an influence of heat energy from the outside is received, for example, when a large temperature difference occurs in an electronic equipment by external factors such as solar insolation or when a temperature difference occurs in the electronic equipment by heat of another device installed in the neighborhood, the influence of the external environment is reduced and the temperature of the equipment is stabilized within an allowable temperature range.

In order to solve the problem, according to an aspect of the invention, an electronic equipment has a structure in which an electronic component contained in a housing is thermally connected to a housing inner wall through plural heat conduction members and a heat conduction control member, and the amount of heat transported from the electronic component to the housing inner wall is controlled by using the heat conduction member, and is characterized in that

the amount of heat to be transported is decreased for a housing surface whose temperature rises by influence of an external environment, the amount of heat to be transported is increased for a housing surface which is not influenced by the external environment, and temperature of the electronic component is stabilized within an allowable temperature range.

More specifically, the electronic equipment according to an aspect of the invention includes, for example, as shown in FIG. 5, a printed board 3, an electronic component 4, a heat conduction member 5, a heat conduction control member 6, a control circuit section 12, and a temperature sensor 13 in a housing 1, and

one of features is a structure in which in order to cool the electronic component 4 mounted on the printed board 3, an upper surface of the electronic component 4 is connected to the heat conduction member 5, and further, the heat conduction member 5 is connected to plural housing inner walls through the heat conduction control member 6.

Besides, the heat conduction control member 6 is a member capable of controlling the amount of heat to be transported from the electronic component 4 to the housing inner wall, and the control thereof is performed by the control circuit section 12 mounted on the printed board 3.

Incidentally, the control circuit section 12 receives the temperature of the electronic component 4 and information of the temperature sensor 13 attached to the housing 1, and controls the amount of heat to be transported from the electronic component 4 to the respective housing inner walls so as to stabilize the temperature of the electronic component 4 within the allowable temperature range.

According to the first solving means of the present invention, there is provided a cooling structure of an electronic equipment in which an electronic component is disposed in a housing and heat is dissipated from a first surface and a second surface of the housing, comprising:

a first heat conduction control member to control an amount of heat transmitted from the electronic component to the first surface of the housing;

a second heat conduction control member to control an amount of heat transmitted from the electronic component to the second surface of the housing;

a first temperature sensor to measure temperature of the first surface of the housing;

a second temperature sensor to measure temperature of the second surface of the housing; and

a control circuit to increase the amount of heat transmitted to a lower temperature one of the first and the second surfaces by controlling to decrease a heat resistance of the corresponding first or second heat conduction control member based on the respective temperatures measured by the first temperature senor and the second temperature sensor.

According to the second solving means of the present invention, there is provided a cooling structure of an electronic equipment in which an electronic component is disposed in a housing and heat is dissipated from a first surface and a second surface of the housing, comprising:

a first heat conduction control member to control an amount of heat transmitted from the electronic component to the first surface of the housing;

a second heat conduction control member to control an amount of heat transmitted from the electronic component to the second surface of the housing;

a first optical sensor to measure light amount of the first surface of the housing;

a second optical sensor to measure light amount of the second surface of the housing; and

a control circuit to increase the amount of heat transmitted to a lower light amount one of the first and the second surfaces by controlling to decrease a heat resistance of the corresponding first or second heat conduction control member based on the respective light amounts measured by the first light amount senor and the second optical sensor.

According to the third solving means of the present invention, there is provided a cooling structure of an electronic equipment in which an electronic component is disposed in a housing and heat is dissipated from a first surface and a second surface of the housing, comprising:

a first heat conduction control member to control an amount of heat transmitted from the electronic component to the first surface of the housing;

a second heat conduction control member to control an amount of heat transmitted from the electronic component to the second surface of the housing;

a first temperature sensor, arranged to the first surface of the housing, to measure outside temperature of the first surface;

a second temperature sensor, arranged to the second surface of the housing, to measure outside temperature of the second surface; and

a control circuit to increase the amount of heat transmitted to a lower outside temperature one of the first and the second surfaces by controlling to decrease a heat resistance of the corresponding first or second heat conduction control member based on the respective temperatures measured by the first temperature senor and the second temperature sensor.

According to the present invention, in an environment in which an influence of heat energy from the outside is received, for example, when a large temperature difference occurs in an electronic equipment by external factors such as solar insolation or when a temperature difference occurs in the electronic equipment by heat of another device installed in the neighborhood, the influence of the external environment can be reduced and the temperature of the equipment can be stabilized within an allowable temperature range.

According to the present invention, since a light shielding plate is eliminated in the environment in which solar insolation is received, the electronic equipment can be miniaturized.

### BRIEF DESCRIPTION OF THE DRAWINGS

FIG. 1 is a perspective view showing an electronic equipment of an embodiment of the invention.

FIG. 2 is a conceptual view showing an electronic equipment of the related art.

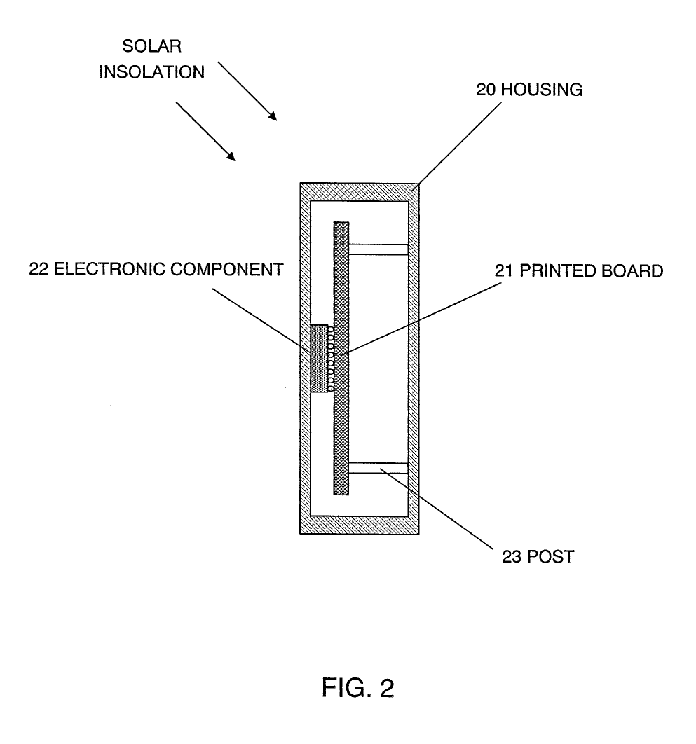

FIG. 3 is a conceptual view showing an electronic equipment of the related art in which a light shielding plate is attached.

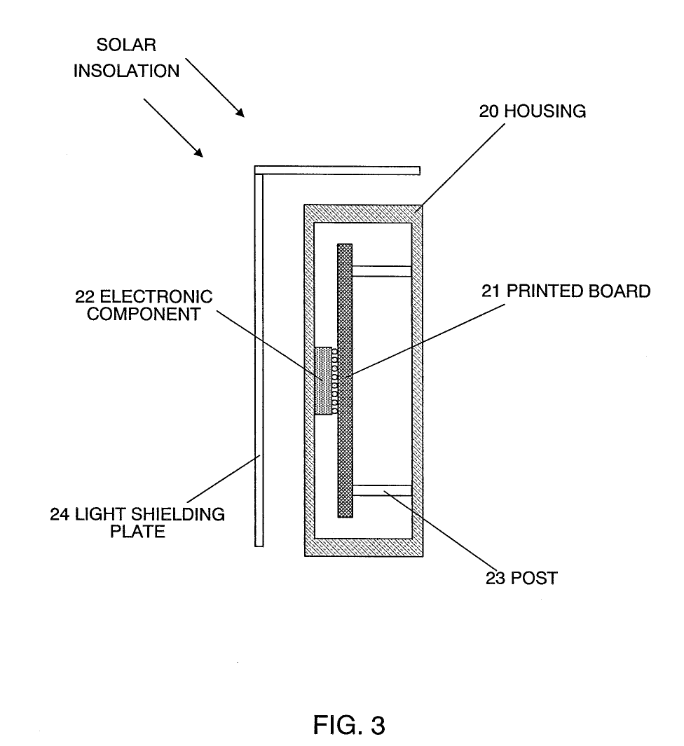

FIG. 4 is a conceptual view showing an electronic equipment of the related art.

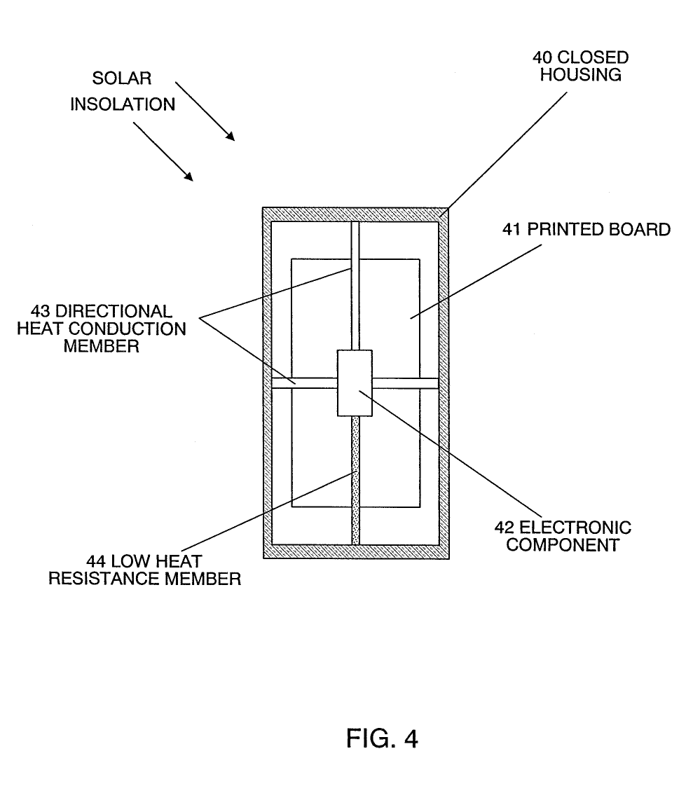

FIG. 5 is a conceptual view showing an electronic equipment of the invention.

FIG. 6 is a side view showing an electronic equipment of an embodiment.

FIG. 7 is an exploded view showing the electronic equipment of the embodiment.

FIG. 8 is a conceptual view showing the electronic equipment of the embodiment.

FIG. 9 is a conceptual view showing operation behavior when the electronic equipment of the embodiment receives insolation.

FIG. 10 is a conceptual view showing operation behavior when the electronic equipment of the embodiment receives insolation.

FIG. 11 is a view showing an example of a control circuit of a Peltier element in the electronic equipment of the embodiment.

FIG. 12 is a conceptual view showing an electronic equipment of embodiment 2.

FIG. 13 is a conceptual view showing an electronic equipment of embodiment 3.

FIG. 14 is a conceptual view showing a high insolation absorption coefficient temperature sensor of embodiment 3.

### DETAILED DESCRIPTION OF THE INVENTION

Hereinafter, embodiments of the invention will be described with reference to the drawings.

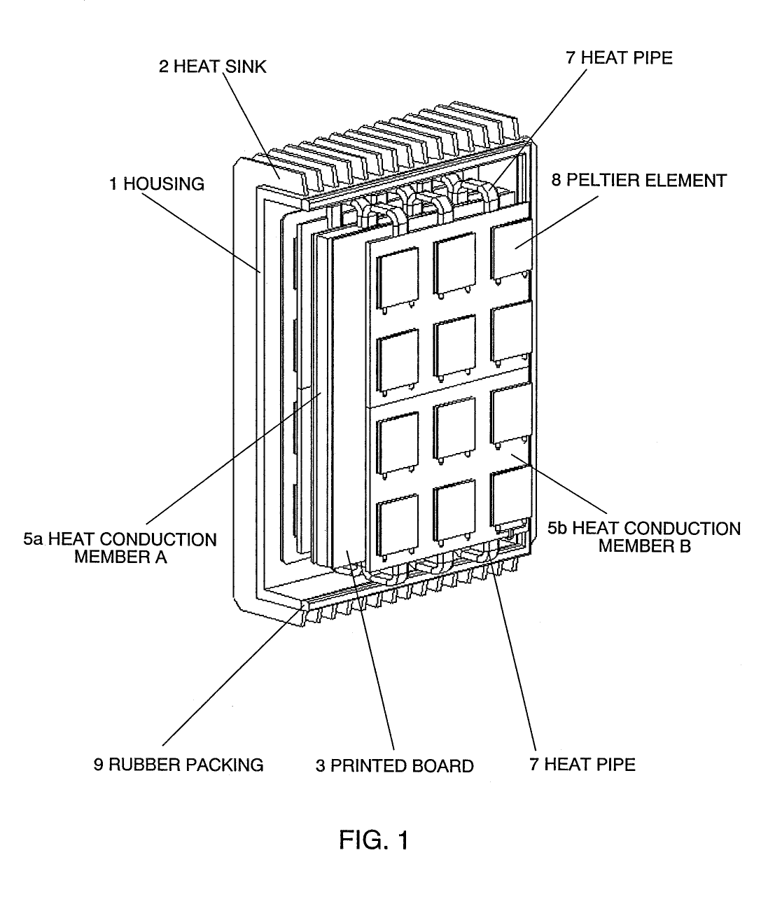

FIG. 1 is a perspective view showing an electronic equipment of an embodiment.

The electronic equipment includes a housing 1, a heat sink 2, a printed board 3, a heat conduction member A 5a, a heat conduction member B 5b, a rubber packing 9, a heat pipe 7, a Peltier element (heat conduction control member) 8, a not-shown electronic component 4, a control circuit section 12 and a temperature sensor 13.

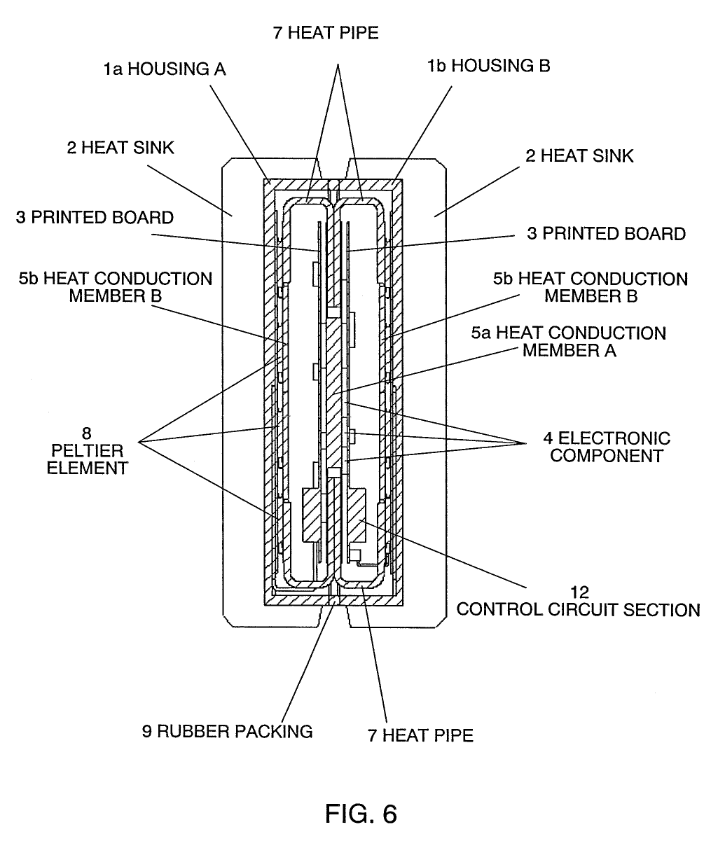

FIG. 6 is a sectional side view showing the electronic equipment of the embodiment.

The electronic equipment includes a housing A 1a and a housing B 1b, and the heat sink 2 is formed on respective housing surfaces (first surface, second surface) and enables heat dissipation to the atmosphere. The housing A 1a and the housing B 1b respectively have sufficient cooling performance, and have structures with substantially equal heat resistances. Incidentally, the rubber packing 9 serving also as a waterproof measure is nipped between the housing A 1a and the housing B 1b in order to reduce the temperature influence by mutual heat conduction.

On the other hand, in the equipment, in order to cool the electronic component 4 mounted on the printed board 3, the electronic component 4 is connected to the heat conduction member A 5a. At this time, in order to efficiently transport the heat of the electronic component 4, the heat conduction member A 5a is made of, for example, high heat conduction metal, such as copper or aluminum, or a plate-like heat pipe. Incidentally, the number of the electronic components 4 connected to the heat conduction member A 5a may be one or two or more.

Besides, the heat conduction member A 5a is connected to the heat conduction member B 5b through the heat pipes 7 attached to the upper and lower surfaces thereof. Similarly to the heat conduction member A 5a, in order to efficiently transport the heat of the electronic component 4, the heat conduction member B 5b can also be made of, for example, high heat conduction metal, such as copper or aluminum, or a plate-like heat pipe. The number of the heat pipes 7 to connect the heat conduction member A 5a and the heat conduction member B 5b is suitably adjusted according to the amount of heat to be transported.

The back surface of the heat conduction member B 5b is connected to the inner walls of the housing A 1a and the housing B 1b through the Peltier element 8 as the heat conduction control member. By this, heat generated from the electronic component 4 is finally transported to the housing inner wall. Here, the Peltier element is a semiconductor element capable of controlling a heat transport amount (heat generation, heat absorption) by the magnitude of a voltage applied to the element. Incidentally, surfaces for heat dissipation are not limited to the two surfaces as shown in the drawing, and heat dissipation may be performed from three or more surfaces.

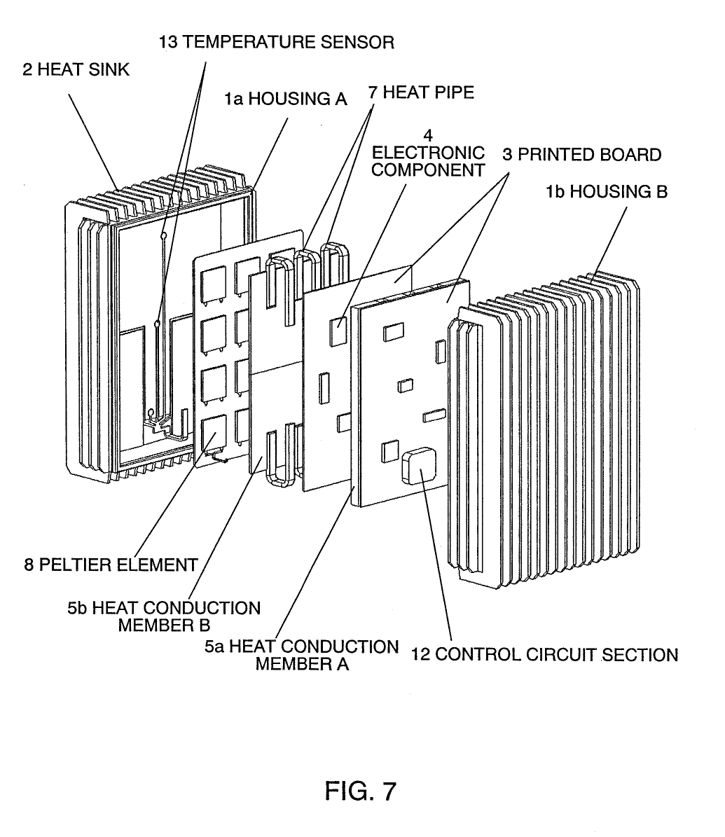

FIG. 7 is an exploded view showing the electronic equipment of the embodiment.

In the electronic equipment, the control circuit section 12 to control the Peltier element 8 is mounted on the printed board 3. Besides, temperature sensors (a first temperature sensor, a second temperature) 13 are buried in the inner walls of the housing A 1a and the housing B 1b, and the temperature information of the housing inner wall is transmitted to the control circuit section 12. In this embodiment, it is assumed that the temperature distribution of the housing inner wall becomes irregular, and the plural temperature sensors 13 are mounted.

Hereinafter, the control behavior of the Peltier element 8 at the time of operation of the electronic equipment will be described.

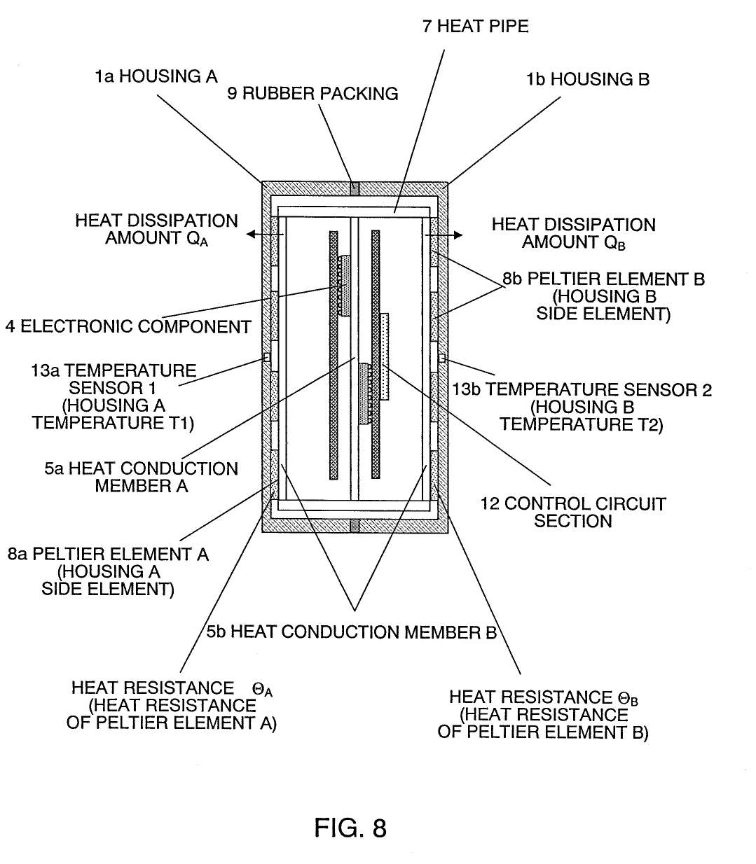

First, as shown in FIG. 8, it is assumed that the electronic equipment is operated in an environment in which solar insolation is not received (in an environment in which influence of heat energy from the outside is not received). At this time, since a large temperature difference does not occur in the electronic equipment, temperature T1 of the housing A 1a and temperature T2 of the housing B 1b become almost equal to each other (T1≈T2). Thus, it is sufficient if the heat is equally transported to the housing A 1a and the housing B 1b to dissipate the heat of the electronic component 4. Then, the control circuit section 12 controls so that heat resistances θ_{A} and θ_{B} of the Peltier element A 8a and the Peltier element B 8b become θ_{A}≈θ_{B}. Then, since the housing A 1a and the housing B 1b have the equal heat resistances, the amount Q_{A} of heat dissipated from the housing A 1a to the outside becomes equal to the amount Q_{B} of heat dissipated from the housing B 1b to the outside. When the total amount of heat which must be dissipated to the outside in order to keep the temperature of the electronic equipment 4 at a target temperature (electronic component control target temperature) is ΔQ, a relation of ΔQ/2=Q_{A}=Q_{B} is established.

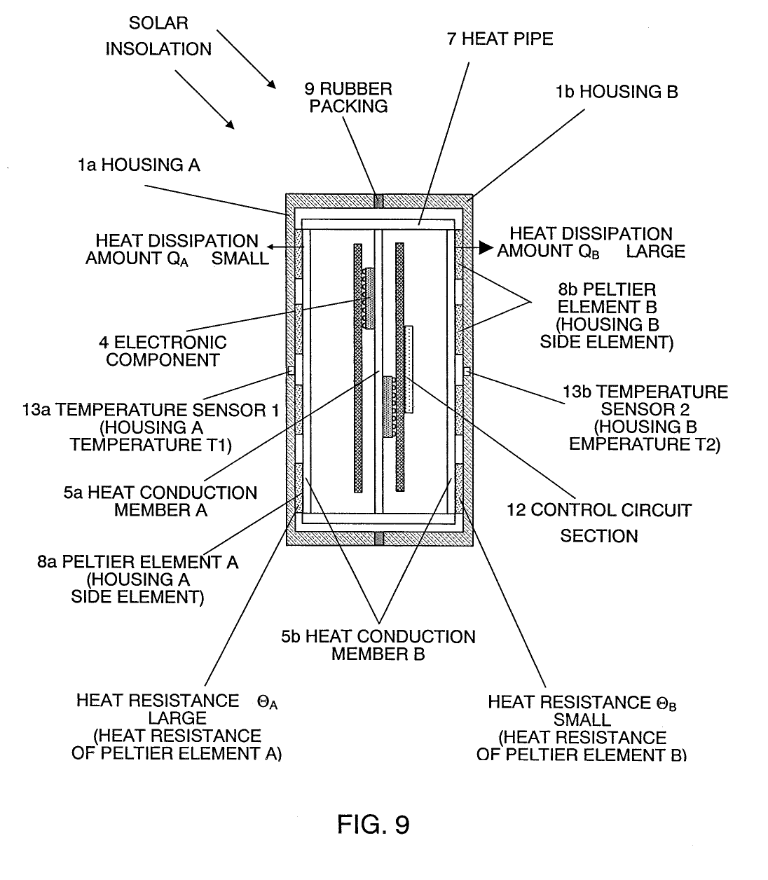

Next, as shown in FIG. 9, it is assumed that the electronic equipment is installed outdoors, and at time t1, the housing A 1a side receives a large amount of insolation. At this time, the temperature of the housing A 1a receiving the solar insolation rises, and T1>T2 is established. Thus, the amount Q_{A} of heat dissipated from the housing A 1a to the outside becomes small as compared with the case where the solar insolation is not received, and cooling efficiency becomes worse. Then, the control circuit section 12 controls the heat resistances of the Peltier element A 8a and the Peltier element B 8b so that θ_{A} becomes large and θ_{B} becomes small. Then, the amount Q_{A} of heat dissipation becomes small as compared with the case where solar insolation is not received. Although the cooling efficiency remains poor, since the heat resistance becomes large, the influence of solar insolation becomes small. On the other hand, in the housing B 1b, since the heat resistance of the Peltier element B 8b becomes small, the amount Q_{B} of heat dissipation is increased as compared with the case where solar insolation is not received. Besides, when the amount ΔQ of heat to be dissipated to the outside in order to keep the temperature of the electronic equipment 4 at the electronic component control target temperature in total is ΔQ, when Q_{A} and Q_{B} are controlled so that a relation of ΔQ=Q_{A}+Q_{B} is established, the temperature of the electronic equipment is kept constant or within the desired temperature range.

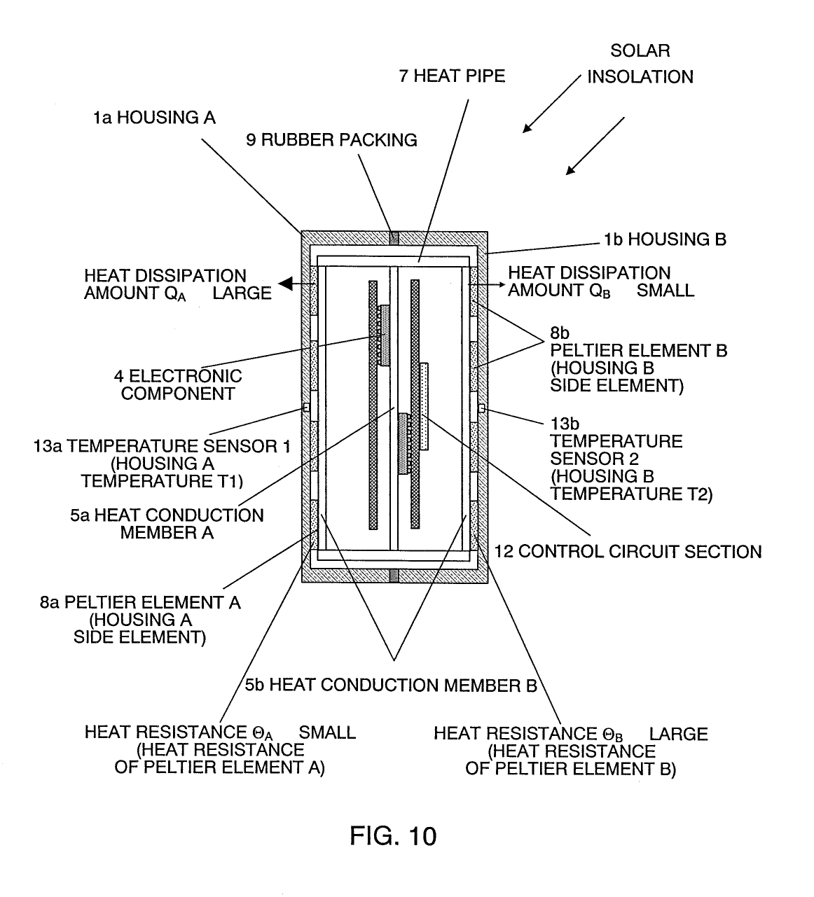

Finally, as shown in FIG. 10, it is assumed that the housing B 1b side receives a large amount of insolation at different time t2 when the insolation direction is changed. Contrary to the case at time t1, since the temperature of the housing B 1b receiving the insolation rises, T1<T2 is established. Thus, the amount Q_{B} of heat dissipated from the housing B 1b becomes small as compared with the case where insolation is not received, and the cooling efficiency becomes worse. Then, contrary to the case at time t1, the control circuit section 12 controls the Peltier element A 8a and the Peltier element B 8b so that θ_{A} becomes small and θ_{B} becomes large. Then, as compared with the case where insolation is not received, the amount Q_{A} of heat dissipated from the housing A 1a is increased, while the amount Q_{B} of heat dissipated from the housing B 1b is decreased. Similarly to the case at time t1, when a relation of ΔQ=Q_{A}+Q_{B} is satisfied in total, the temperature of the electronic component 4 is kept constant or within the desired temperature range.

Incidentally, in the electronic equipment of the embodiment, it is needless to say that the same effect is obtained not only in the case where insolation is received, but also in the case where a different device is installed near one of the housing A 1a and the housing B 1b and the influence of unbalance heat energy is received.

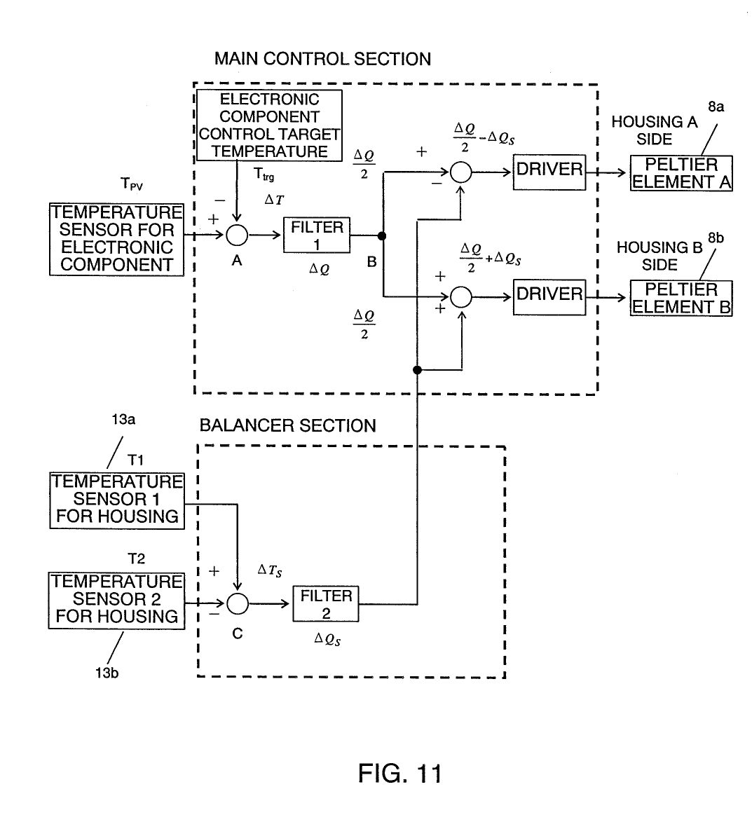

FIG. 11 shows an example of the control circuit section 12 of the Peltier element 8.

The control circuit section 12 includes a main control section and a balancer section.

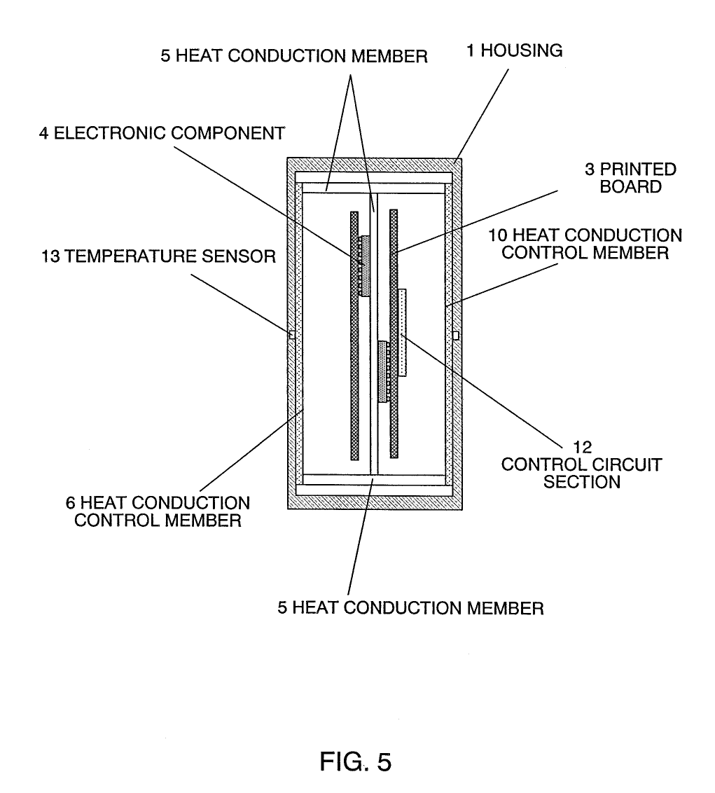

First, at point A in the drawing, the main control section obtains a difference ΔT between electronic component temperature T_{PV} monitored by the electronic component temperature sensor and target temperature (electronic component control target temperature T_{trg}) of the electronic component. Incidentally, since an electronic component temperature sensor (third temperature sensor) is often mounted in the electronic component, it is not shown in FIG. 5 to FIG. 10. Incidentally, in addition to the mounting in the electronic component, the temperature sensor may be mounted on the outside. Besides, the electronic component control target temperature T_{trg} can be set in advance.

Next, from the temperature difference ΔT, the main control section uses a filter 1 to determine the amount ΔQ of heat which must be dissipated to the outside in order to cause the electronic component temperature T_{PV} to become the electronic component control target temperature T_{trg}. In the filter 1, in order to convert ΔT to ΔQ, it is necessary to previously obtain a relation between both by heat simulation or a real machine test. For example, based on data obtained by the heat simulation or the real machine test, the correspondence relation between the value of ΔT and the value of ΔQ may be previously stored in a table, or an expression for obtaining ΔQ from ΔT may be previously obtained and set. In addition to this, ΔT may be converted to ΔQ by an appropriate method.

Then, at point B in the drawing, ΔQ obtained by the filter 1 is divided into the heat amounts Q_{A} and Q_{B} which must be dissipated by the respective housing surfaces. In this embodiment, for simplification, the case where the control is performed for two systems of the housing A side and the housing B side is described. At point B in the drawing, in order to equate the amount Q_{A} of heat dissipated from the housing A 1a to the amount Q_{B} of heat dissipated from the housing B 1b, division into two equal parts is performed so that Q_{A}=Q_{B}=ΔQ/2 is established. Incidentally, the heat dissipation amount may be divided at a previously determined ratio. For example, the heat dissipation amount may be divided according to the area of each surface for heat dissipation, the number of Peltier elements of each surface, or heat dissipation power.

On the other hand, when a large temperature difference occurs in the electronic equipment by solar insolation, the balancer section adjusts Q_{A} and Q_{B}. At point C in the drawing, the balancer section obtains a difference ΔT_{S} between the electronic equipment side surface temperatures T1 and T2 monitored by housing temperature sensors 1 and 2. Then, the filter 2 is used to obtain a difference ΔQ_{S} between the amounts of dissipation heat to be given to the Peltier element A and the Peltier element B in order to cause the temperature difference ΔT_{S} between both to become 0. In this filter 2, similarly to the case of the filter 1, in order to convert ΔT_{S} to ΔQ_{S}, it is necessary to previously obtain the relation of both by simulation or the like. Incidentally, the process by the balancer section may be performed when a large temperature difference occurs in the electronic equipment (for example, when the difference ΔT_{S} between T1 and T2 is larger than a previously determined threshold value), or the difference ΔT_{S} between the electronic component temperature T_{PV} measured by the electronic component temperature sensor and the electronic component control target temperature T_{trg} is larger than a previously determined threshold value.

Then, in order to eliminate the temperature difference ΔT_{S} between T1 and T2 and to cause the electronic component temperature T_{PV} to approach the electronic component control target temperature T_{trg}, ΔQ_{S} has only to be added and subtracted. Thus, the amounts of heat to be dissipated by the respective Peltier elements, Q_{A}=ΔQ/2−ΔQ_{S} and Q_{B}=ΔQ/2+ΔQ_{S}, are obtained. The thus determined Q_{A} and Q_{B} are transmitted to the Peltier elements 8 through drivers mounted in the main control section. The Peltier element 8 controls the heat transport amount by turning on/off all of or part of power sources, or by changing the magnitude of voltage supplied to the elements. Incidentally, the control circuit section 12 may control only the heat resistance of a lower temperature one of the housings A 1a and B 1b and may not control the higher temperature one.

As described above, according to the embodiment, in an environment in which the influence of heat energy from the outside is received, for example, when a large temperature difference occurs in the electronic equipment by external factors such as solar insolation, or when a temperature difference occurs in the electronic equipment by heat of a different device installed in the neighborhood, the influence of the external environment can be reduced and the temperature of the equipment can be stabilized within the allowable temperature range.

### MODIFIED EXAMPLES

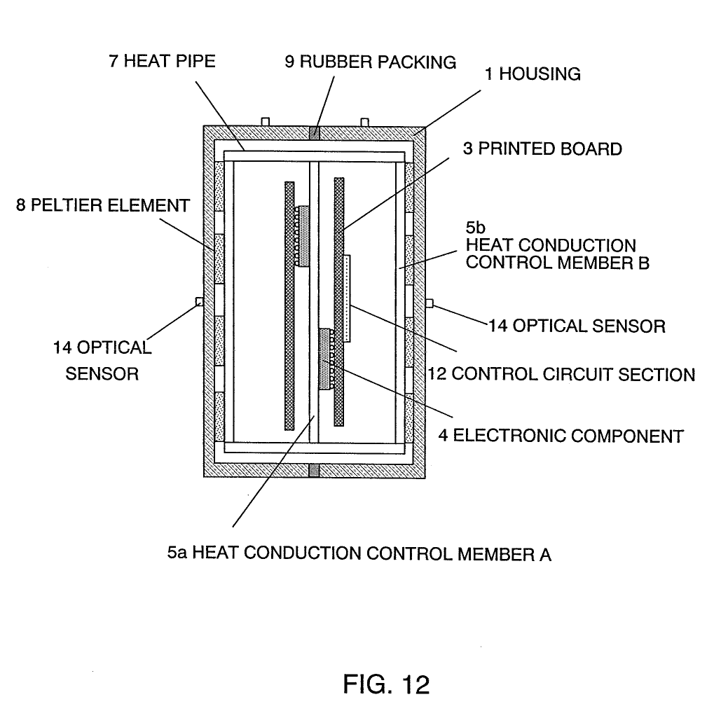

FIG. 12 is a structural view of an electronic equipment when an optical sensor is used.

As another unit configured to quickly sense the influence of solar insolation, an optical sensor 14 as shown in FIG. 12 may be used. By this sensor 14, a surface receiving solar insolation is quickly sensed, and temperature control with sufficient time can be performed. Besides, the optical sensor 14 is desirably mounted on each of, for example, a front surface, a side surface and a ceiling surface of a housing 1, which receive the influence of solar insolation. Incidentally, in this electronic equipment, the balancer section shown in FIG. 11 obtains a difference between light amounts measured by the optical sensors 14 instead of obtaining the temperature difference by the temperature sensors.

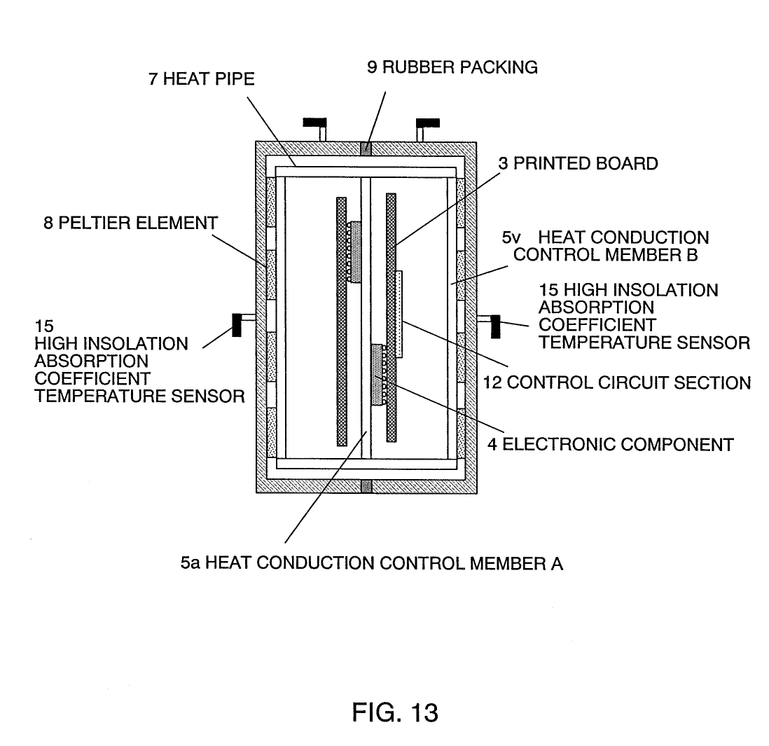

FIG. 13 is a structural view of an electronic equipment in a case where a high insolation absorption coefficient temperature sensor is used.

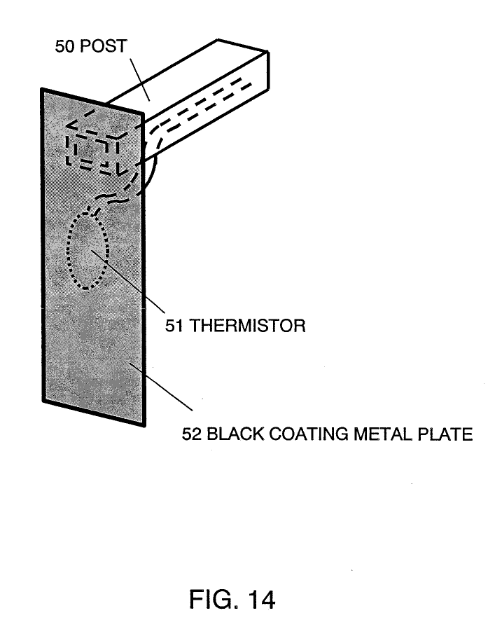

As another unit configured to quickly sense the influence of solar insolation, a high insolation absorption coefficient temperature sensor 15 as shown in FIG. 13 may be used. As shown in FIG. 14, the sensor 15 has such a structure that a thermistor 51 is attached to a metal plate 52 coated with, for example, black paint, the metal plate is fixed to a housing 1 by a hollow post 50, and a thermistor cable passes through a hollow portion of the post 50 and is fed into the inside of the housing. Since the black paint coated on the metal plate 52 has a high insolation absorption coefficient, temperature rise is sensitive to the reception of insolation, and the direction of the insolation, so-called insolation influence surface can be quickly sensed. Incidentally, for the purpose of accurately sensing the influence of insolation, it is desirable that the black coated metal plate 52 is mounted while a distance from the heating housing surface is secured by the post or the like to a certain degree. Besides, in order to raise the temperature sensitivity, that is, in order to decrease the thermal time constant, it is appropriate that the metal plate is made as thin as possible. Besides, the sensor 15 is desirably mounted on each of, for example, a front surface, a side surface and a ceiling surface of the housing which receives the influence of solar insolation. Further, as the external environment change other than the solar insolation, also in the case where the outside air temperature is changed or a heat generating body exists in the neighborhood, the influence can be quickly sensed.

### EXAMPLE OF THE STRUCTURE

In one of cooling structures of the electronic equipment of the embodiment, in an environment in which influence of heat energy from the outside is received, for example, when a large temperature difference occurs in the electronic equipment by external factors such as solar insolation, or when a temperature difference occurs in the electronic equipment by heat of a different device installed in the neighborhood, the amount of heat to be transported is decreased for the housing surface whose temperature rises by the influence of the external environment, and the amount of heat to be transported is increased for the housing surface which is not influenced by the external environment, and the temperature of the electronic component is stabilized within the allowable temperature range.

In the electronic equipment, the electronic component contained in the housing is thermally connected to the housing inner wall through the plural heat conduction members and the heat conduction control member, and the heat is transported from the electronic component to the housing inner wall.

Besides, one of the electronic equipment devices of the embodiment is, for example, an electronic equipment device including a metal housing, which includes

a heat conduction member connected to an electronic component in the electronic equipment device,

a heat conduction control member to connect the heat conduction member and the housing,

a control unit to control the heat conduction member, and

a temperature sensor to measure temperature change of the housing, and in which

the control unit controls the heat conduction control member based on a measurement result of the temperature sensor, and thermally connects the heat conduction member and the housing.

The invention can be used for, for example, the industry relating to the electronic equipment.

What is claimed is:

1. A cooling structure of an electronic equipment in which an electronic component is disposed in a housing and heat is dissipated from a first surface and a second surface of the housing, comprising:
a first heat conduction control member to control an amount of heat transmitted from the electronic component to the first surface of the housing;
a second heat conduction control member to control an amount of heat transmitted from the electronic component to the second surface of the housing;
a first temperature sensor to measure temperature of the first surface of the housing;
a second temperature sensor to measure temperature of the second surface of the housing; and
a control circuit to increase the amount of heat transmitted to a lower temperature one of the first and the second surfaces by controlling to decrease a heat resistance of the corresponding first or second heat conduction control member based on the respective temperatures measured by the first temperature senor and the second temperature sensor.

2. The cooling structure of the electronic equipment according to claim 1, wherein the control circuit decreases the amount of heat transmitted from the electronic component to a higher temperature one of the first and the second surfaces or the amount of heat transmitted from the higher temperature one to the electronic component by controlling to increase the heat resistance of the corresponding first or second heat conduction member.

3. The cooling structure of the electronic equipment according to claim 1, further comprising:
a first heat conduction member to transmit heat of the electronic component to the first surface of the housing; and
a second heat conduction member to transmit heat of the electronic component to the second surface different from the first surface, wherein
the first heat conduction control member intervenes between the housing and the first heat conduction member, and
the second heat conduction control member intervenes between the housing and the second heat conduction member.

4. The cooling structure of the electronic equipment according to claim 1, wherein the first and the second heat conduction control members are Peltier elements.

5. The cooling structure of the electronic equipment according to claim 1, wherein
the housing includes a first housing having the first surface and a second housing having the second surface, and
a heat shielding member to reduce a temperature influence due to heat conduction is provided between the first housing and the second housing.

6. The cooling structure of the electronic equipment according to claim 1, further comprising a third temperature sensor to measure temperature of the electronic component, wherein
the control circuit obtains a heat dissipation amount of the entire equipment based on the temperature measured by the third temperature sensor and a previously determined target temperature, and
the control circuit controls the heat resistance of the first or the second heat conduction control member to cause a total of the amount of heat transmitted to the first surface and the amount of heat transmitted to the second surface to become the obtained heat dissipation amount of the entire equipment, according to a temperature difference between the respective temperatures measured by the first temperature sensor and the second temperature sensor, and keeps the temperature of the electronic component within an allowable temperature range close to the target temperature.

7. The cooling structure of the electronic equipment according to claim 1, wherein
a correspondence relation of a temperature difference between the respective temperatures measured by the first temperature sensor and the second temperature sensor and a variation in the amounts of heat transmitted to the first surface and the second surface is previously set,
the control circuit obtains the variation in the amounts of heat transmitted to the first surface and the second surface based on the temperature difference between the respective temperatures measured by the first temperature sensor and the second temperature sensor,
the control circuit increases the amount of heat transmitted to the lower temperature one of the first and the second surfaces by the obtained variation in the amounts of heat, and
the control circuit decreases the amount of heat transmitted to the higher temperature one of the first and the second surfaces by the obtained variation in the amounts of heat.

8. A cooling structure of an electronic equipment in which an electronic component is disposed in a housing and heat is dissipated from a first surface and a second surface of the housing, comprising:
a first heat conduction control member to control an amount of heat transmitted from the electronic component to the first surface of the housing;
a second heat conduction control member to control an amount of heat transmitted from the electronic component to the second surface of the housing;
a first optical sensor to measure light amount of the first surface of the housing;
a second optical sensor to measure light amount of the second surface of the housing; and
a control circuit to increase the amount of heat transmitted to a lower light amount one of the first and the second surfaces by controlling to decrease a heat resistance of the corresponding first or second heat conduction control member based on the respective light amounts measured by the first light amount senor and the second optical sensor.

9. The cooling structure of the electronic equipment according to claim 8, wherein the control circuit decreases the amount of heat transmitted from the electronic component to a higher light amount one of the first and the second surfaces or the amount of heat transmitted from the higher light amount one to the electronic component by controlling to increase the heat resistance of the corresponding first or second heat conduction member.

10. The cooling structure of the electronic equipment according to claim 8, further comprising:
a first heat conduction member to transmit heat of the electronic component to the first surface of the housing; and
a second heat conduction member to transmit heat of the electronic component to the second surface different from the first surface, wherein
the first heat conduction control member intervenes between the housing and the first heat conduction member, and
the second heat conduction control member intervenes between the housing and the second heat conduction member.

11. The cooling structure of the electronic equipment according to claim 8, wherein the first and the second heat conduction control members are Peltier elements.

12. The cooling structure of the electronic equipment according to claim 8, wherein
the housing includes a first housing having the first surface and a second housing having the second surface, and
a heat shielding member to reduce a light amount influence due to heat conduction is provided between the first housing and the second housing.

13. The cooling structure of the electronic equipment according to claim 8, further comprising a third optical sensor to measure light amount of the electronic component, wherein
the control circuit obtains a heat dissipation amount of the entire equipment based on the light amount measured by the third optical sensor and a previously determined target light amount, and
the control circuit controls the heat resistance of the first or the second heat conduction control member to cause a total of the amount of heat transmitted to the first surface and the amount of heat transmitted to the second surface to become the obtained heat dissipation amount of the entire equipment, according to a light amount difference between the respective light amounts measured by the first optical sensor and the second optical sensor, and keeps the light amount of the electronic component within an allowable light amount range close to the target light amount.

14. The cooling structure of the electronic equipment according to claim 8, wherein
a correspondence relation of a light amount difference between the respective light amounts measured by the first optical sensor and the second optical sensor and a variation in the amounts of heat transmitted to the first surface and the second surface is previously set,
the control circuit obtains the variation in the amounts of heat transmitted to the first surface and the second surface based on the light amount difference between the respective light amounts measured by the first optical sensor and the second optical sensor,
the control circuit increases the amount of heat transmitted to the lower light amount one of the first and the second surfaces by the obtained variation in the amounts of heat, and
the control circuit decreases the amount of heat transmitted to the higher light amount one of the first and the second surfaces by the obtained variation in the amounts of heat.

15. A cooling structure of an electronic equipment in which an electronic component is disposed in a housing and heat is dissipated from a first surface and a second surface of the housing, comprising:
a first heat conduction control member to control an amount of heat transmitted from the electronic component to the first surface of the housing;
a second heat conduction control member to control an amount of heat transmitted from the electronic component to the second surface of the housing;
a first temperature sensor, arranged to the first surface of the housing, to measure outside temperature of the first surface;
a second temperature sensor, arranged to the second surface of the housing, to measure outside temperature of the second surface; and
a control circuit to increase the amount of heat transmitted to a lower outside temperature one of the first and the second surfaces by controlling to decrease a heat resistance of the corresponding first or second heat conduction control member based on the respective temperatures measured by the first temperature senor and the second temperature sensor.

16. The cooling structure of the electronic equipment according to claim 15, wherein
each of the first and the second temperature sensors includes:
a metal plate coated with black paint for raising a temperature change to reception of insolation; and
a thermistor attached to the metal plate, and
each of the first and the second temperature sensors is attached to the first surface or the second surface of the housing through a post.
